(19) United States
(12) Patent Application Publication
(10) Pub. No.: US 2009/0173363 A1
(43) Pub. Date: Jul. 9, 2009

(54) System for Cleaning an Oil Tank and Method of Cleaning an Oil Tank

(75) Inventor: Jonathan Wahnich, Paris (FR)

Correspondence Address: ARENT FOX LLP, 1050 CONNECTICUT AVENUE, N.W., SUITE 400, WASHINGTON, DC, 20036, US

(73) Assignee: PETROJET INTERNATIONAL, Paris (FR)

(21) Appl. No.: 12/300,946

(22) PCT Filed: May 15, 2006
(86) PCT No.: PCT/FR06/01090

§ 371 Date: Jan. 5, 2009

(51) Int. Cl. B08B 9/093

(52) U.S. Cl. 134/22.18; 134/111

(57) ABSTRACT

The invention concerns a system for putting back in suspension a sediment that has, by deposition, formed a layer (3) on the bottom (1b) of a tank (1) with a floating roof (2) containing crude oil, said device comprising: —at least one pipe (11) for sucking out and re-injecting the oil contained in said tank (1); —a pump (7) for providing circulation of the oil in said pipe (11); —a filtration device (9) intended to eliminate the inorganic elements contained in the crude oil; and —injection lances (5) each comprising at least one injection orifice (8a, 8b, 8c) sending a jet in the direction of the layer of sediment; the filtration device (9) comprises at least a first (15a) and a second filter (15b) mounted in parallel and connected to the suction and re-injection pipe (11) by means of a switching device (16, 17) for directing the flow of oil selectively to the first (15a) or second filter (15b). The invention also concerns a method of putting a layer of sediment back in suspension.

The invention relates to a system for putting back in suspension a sediment which has, by deposition, formed a layer on the bottom of a tank with a floating roof containing crude oil as well as a method for implementing a system.

It is known that crude oil storage tanks are generally cylindrical tanks with floating roofs. The structure of the roof is thus at a more or less high level with respect to the ground according to the quantity of crude oil contained in the tank. Of course, the periphery of the floating roof includes sealing members preventing the oil from leaking at the periphery of the roof.

It has been found that in these storage tanks, a sediment progressively deposits on the bottom of the tank and is composed for a major part of the heaviest fractions of the stored crude oil, more particularly paraffinic compounds and inorganic elements such as water, sand, rust particles or similar. This sediment, also called “sludge”, is liable to compose very thick layers, 1 or 2 metres high, or even more, on the bottom of the tank and it is necessary to clean the tanks and to remove this sediment. As a matter of fact, if the sediment accumulates on the bottom of the tank and if the floating roof goes down to the bottom, the risk exists that the floating roof and a point of the sediment deposition come in contact which puts the roof off balance and blocks it in an oblique position in the side wall of the tank; now the weight of the floating roof amounts to several hundreds of tons and repairing such an incident would entail enormous costs. In addition, the sediment occupies an important volume which can no longer be used for storing oil. Thus, the layer of the sediment reduces the storage capacity of the tank.

The floating roof is provided with sleeves in which supporting legs are inserted, which make it possible to support the roof and to prevent the collapsing thereof when the tank is empty. Thus, when the tank is emptied, the roof goes down to the bottom and all supporting legs rest on the bottom. Consequently, the roof is kept at a certain distance from the bottom and it is possible to completely empty the tank of the liquid crude oil it contains in order to extract the sediment.

In order to extract the sediment, it has been proposed to remove it manually, with the personnel going into the tank through the manholes it is provided with, at the base of the side wall thereof. This operation is time-consuming, hard and costly and the sediment which is extracted from a tank must be evacuated while avoiding any pollution; it is generally incinerated. Such a cleaning operation means prohibitive global costs.

It has also been already proposed to introduce through a manhole, when the tank is empty, a central stirrer positioned close to the layer of sediment and which can rotate about a vertical axis; such a stirrer uses the thyrotrophic characteristic of the sediment to try and put it back in suspension when liquid oil has been re-introduced into the tank, but the influence thereof is only localised to the central area of the bottom of the tank and in addition the power which is required for rotating it at an efficient speed entails the creation of an emulsion composed of the water contained in the sediment and the crude oil, an emulsion which is highly undesirable for the utilisation of the crude oil stored in the tank. Such a cleaning device is thus not satisfactory.

In order to solve these problems, it is known to put back the sediment in suspension in the crude oil by generating turbulence and/or vortexes in the whole volume of the liquid oil which lies above the sediment, and to send sufficiently powerful oil jets onto the sediment so that it is progressively put back in suspension. Thus, it is not necessary to empty the tank and the layer of sediment slowly disappears and is mixed inside the liquid crude oil which reclaims a part of the sediment since a part of the sediments is put back in suspension and does not need to be extracted from the tank to be destroyed.

For this purpose, systems for putting back in suspension a sediment are known, which are equipped with a pump making it possible to suck the oil through a pipe and then to re-inject the oil using lances carried by the floating roof. The lances replace the supporting legs of the floating roof and include injection orifices sending jets in the direction of the layer of the sediment in order to put it back in suspension.

A system of the prior art more particularly provides the lances with heads mounted to rotate freely with respect to the axis of the lance. The heads of the lances are equipped with an orifice oriented towards the bottom of the tank and thus towards the sediments, and with two side orifices the axis of which does not cross the axis of rotation of the heads. Thus, a vortex volume is generated by the lance and makes it possible to put back the layer of sediment in suspension. However, the pressure at the orifice outlets must be sufficient to enable the putting back in suspension of the layer. Consequently, the section of the injection orifices must be sufficiently small so that, with the rate generated by the pump, the vortex volume generated by one lance cuts the vortex volume caused by the adjacent lances.

However, the section of the injection orifices is so small that particles in suspension in the tank are liable to clog said orifices.

In order to remedy this problem, it is known to provide the pipe for sucking and re-injecting the oil with a filter. Thus, the solid particles such as sand, small rocks or rust are stopped by the filter. In addition, the filtration device makes it possible to clean the tank and to protect all the equipment downstream of said filtration device.

As a counterpart, however, the filter causes a pressure drop upstream of the pump which increases with the quantity of particles trapped in the filter. Thus, after an extended utilisation, a pressure drop at the level of the filter causes a reduction in the pressure available at the pump outlet. Consequently, the installation must be stopped in order to clean the filter.

The invention aims at remedying these problems by providing a system for putting back in suspension a sediment which makes it possible to filtrate the particles contained in the tank while enabling a continuous operation of the installation.

For this purpose, according to a first aspect, the invention provides a system for putting back in suspension a sediment that has, by deposition, formed a layer on the bottom of the tank with a floating roof containing crude oil, said device comprising:
at least one pipe for the sucking out and re-injecting the oil contained in said tank;
a pump for providing a circulation of the oil in said pipe;
a filtration device intended to eliminate the inorganic elements contained in the crude oil; and
injection lances for the oil carried by the floating roof and each comprising at least one injection orifice sending a jet in the direction of layer of sediment;
   said suction and re-injection pipe being connected at the upstream end thereof to the tank and at the downstream end thereof to the injection lances.

The filtration device comprises at least a first and a second filter mounted in parallel and connected to the suction and re-injection pipe by means of a switching device making it possible to direct the flow of oil selectively to the first or the second filter.

Thus, when the flow of oil is directed to the second filter, maintenance operations can be carried on the first filter and vice versa.

Advantageously, the filters are removable basket filters. Thus, the basket of the filter can be disengaged and cleaned easily.

Advantageously, the switching device includes one three-way valve positioned upstream of the first and the second filter and further comprises a second three-way valve positioned downstream of the first and the second filter.

Thus, the switching device makes it possible to direct the flow of oil selectively towards the first or the second filter.

Advantageously, the filtration device includes, upstream and downstream of each filter, a pressure gauge making it possible to measure the pressure drop between the inlet and the outlet of the filter. Thus, the user can easily know whether one of the filters requires cleaning operations.

Advantageously, the filtration device is connected to the suction pipe upstream of the pump. Then, the filtration device makes it possible to protect the pump and the equipment positioned downstream of the pump.

Advantageously, the lances have heads mounted to rotate freely with respect to the axis of the lances, with said heads comprising at least two side injection orifices, the outlet axis of which does not cross the rotation axis of the heads. Preferably, the heads are further equipped with a third injection orifice, the outlet axis of which is oriented towards the bottom of the tank.

In one embodiment of the invention, the system for putting back in suspension includes a first n-way distribution device making it possible to connect the oil suction and re-injection pipe to the oil injection lances and further comprises n p-way distribution devices connected on the one hand to the first distribution device and on the other hand to p oil injection lances. Thus, a pump makes it possible to supply n*p injection lances.

In one embodiment of the invention, the system is modular and can include at least a second pipe associated with the first one. The second suction pipe is also connected, at the upstream end thereof, to the tank and at the downstream end thereof to the injection lances and is also equipped with a second pump for providing the circulation of the oil in said second pipe and a filtration device. Then, the system supplies a large number of lances so as to position the lances at a short distance from each other on the whole surface of the floating roof. Consequently, the system is modular and may include one or several pipes positioned in parallel.

According to a second aspect, the invention relates to a method for putting back in suspension a sediment which has, by deposition, formed a layer on the bottom of the tank with a floating roof containing crude oil, said method providing:
the suction of the crude oil out of the tank using a pump and an oil suction and re-injection pipe;
the filtering of the crude oil using a filtration device comprising at least a first and a second filter mounted in parallel and connected to the suction and re-injection pipe using a switching device making it possible to direct the flow of oil selectively to the first or the second filter;
the injecting of the crude oil into the tank using lances carried by a floating roof positioned vertically above the sediment and each including at least one injection orifice sending a jet directed to the layer of sediment.

The method further provides to switch the flow of oil from the first to the second filter or vice versa and to carry out maintenance operations on the filter which does no longer receive the flow of oil.

Advantageously, the method further provides to measure the pressure drop between the inlet and the outlet of the filter to which a flow of oil is directed, to compare the pressure drop to a set value and to switch the flow of oil if the pressure drop measured exceeds the set value.

Other aims and advantages of the invention will appear upon reading the following description while referring to the appended drawings, wherein:

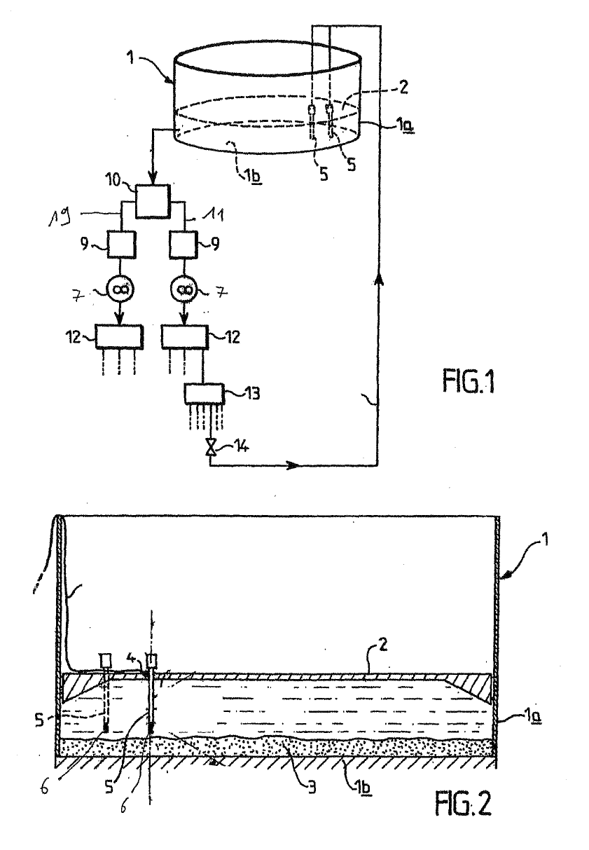

FIG. 1 is a schematic diagram of a system for putting back in suspension a sediment according to the invention;

FIG. 2 is a schematic diagram in cross-section of a tank of crude oil with a floating roof wherein a lance for the re-injection of the pumped crude oil has been positioned as indicated in FIG. 1, the other lances not being illustrated;

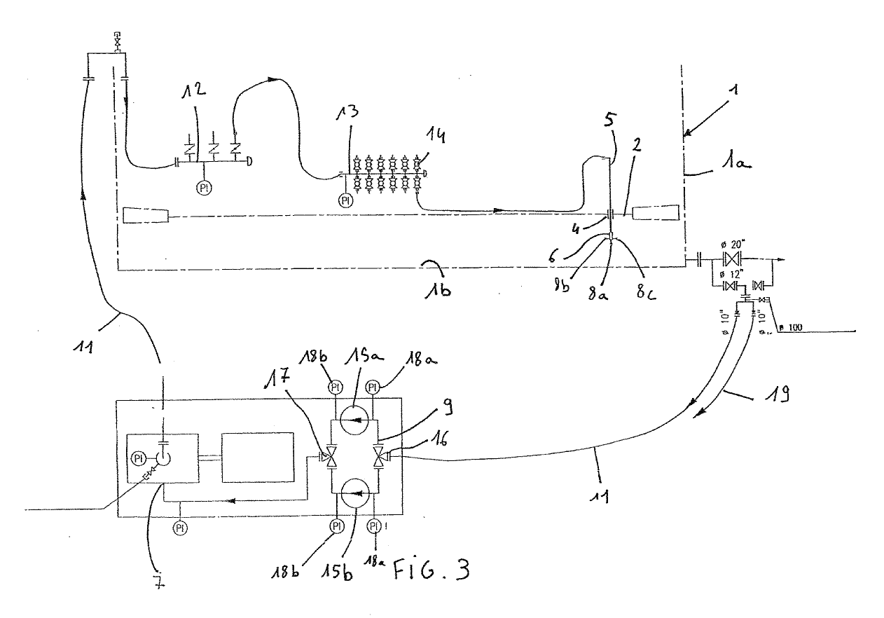

FIG. 3 is a schematic illustration of a system according to the invention, with a filtration device being shown in greater details.

In FIGS. 1 to 3, a tank 1 for storing crude oil is shown. The tank 1 is composed of a cylindrical side wall 1a, the base 1b of which is the bottom of tank 1. The tank 1 is provided with a roof 2 floating on the crude oil and the periphery of which includes filling members not shown.

Conventionally, such a tank may have a diameter of approximately 50 m and a height of 15 m. In such a tank, the oil progressively settles and generates a sediment 3 which composes the layer on the bottom of the tank lb. The layer 3 can reach several meters in height and its surface is relatively irregular. The sediment 3 is generally of a thyrotrophic nature.

Advantageously, a series of analyses is carried out prior to the installation of the system. As a matter of fact, a map of the layer of the sediment 3 is drawn which makes it possible to determine the height where the floating roof 2 and the orifices 8a, 8b, 8c of the lances 5 will be positioned. In addition, the density, the viscosity and the composition of the layer of sediment 3 and of the crude oil are analysed and samples of the crude oil containing variable percentages of sediment 3 put back in suspension are also analysed.

Depending on the map of the layer of sediment 3, the tank 1 is partially emptied. Assuming that the thickness of the layer of sediment 3 is 1 metre, approximately 3 metres of crude oil remain in the tank 1 above the sediment 3. Thus, the roof 2 is about 4 metres above the bottom 1b of the tank 1.

In the example disclosed, the floating roof 2 is provided with 72 supporting legs which go through the roof 2 through supporting leg sleeves referenced 4 on FIGS. 2 and 3. Such supporting legs have a length ranging from 1.8 to 2.2 m. The supporting legs are replaced one after the other by lances 5 positioned in the sleeves 4.

The lances 5 are provided in the lower part thereof, with heads 6 mounted to rotate about the longitudinal axis of the lances 5. Advantageously, the heads 6 of the lances 5 are provided with three injection orifices 8a, 8b, 8c. A first orifice 8a is oriented downwards along the longitudinal axis of the lance 5 whereas the two other orifices 8b, 8c are positioned laterally. The outlet axis of the side orifices 8b, 8c does not cross the rotation axis of the head 6. Thus, the injection of oil through the side orifices causes the rotation of the head which causes a vortex volume. Advantageously, the outlet axis of both side orifices 8b, 8c are parallel and symmetrical with respect to the axis of rotation of the head 6, on the lance 4. The outlet axes of the orifices are for example inclined by 30° with respect to a radial plane of the head 6.

In one embodiment of the invention, the section of the orifices 8a, 8b, 8c is approximately 5 mm.

The injection orifices 8a, 8b, 8c of the lances 5 are generally positioned approximately 50 cm above the layer of sediment 3.

At least one crude oil suction and re-injection pipe 11 is connected, at the upstream end thereof, to the tank 1 and at the downstream end thereof to the injection lances 5 and one pump 7 provides the circulation of the oil to circulate in the pipe 11. In one embodiment of the invention, the pump 7 is a processing cavity pump with a rate of approximately 360 m³/hr. It should be noted that the expression “suction and re-injection pipe” means all the pipes connecting the various elements of the system.

The filtration device 9 is positioned upstream of the pump 7 and makes it possible to eliminate the inorganic elements which can be found in the pumped oil.

According to the invention, the filtration device, shown in greater details in FIG. 3, is composed of a first filter 15a and a second filter 15b connected in parallel to the suction pipe 11. The switching device makes it possible to direct the flow of oil selectively to the first 15a or to the second filter 15b. Thus, when one of the filters 15a gets clogged, the flow of oil is oriented to the other filter 15b. Advantageously, the filters 15a, 15b are basket filters, the nominal diameter which is 250 mm. A basket filter includes a housing in which a removable rigid basket, for example a metallic basket, is introduced, provided with holes through which the purified fluid flows. According to the present invention, the diameter of the holes is approximately 1 or 2 mm. The basket enables a cleaning of the fluid by retaining the side particles having dimensions above those of the holes in the basket. This type of filter is particularly adapted to the present invention since the basket is removable and enables a quick and easily cleaning of the filter.

In a preferred embodiment of the invention illustrated in FIG. 3, the switching device includes a three-way valve 16 positioned upstream of the filtration device. The three-way valve 16 is connected on the one hand to the pipe 10 and on the other end to the inlet of the first filter 15a and to the inlet of the second filter 15b. The valve 16 directs the flow of oil either to the inlet of the first filter 15a or to the inlet of the second filter 15b. The switching device further comprises a three-way valve 17 positioned downstream of the filtration device 9.

Advantageously, the filtration device 9 further includes for each filter 15a, 15b a pressure gauge 18a, 18b respectively positioned upstream of the filter 15a, 15b and downstream of the filter 15a, 15b. The pressure gauges 18a, 18b make it possible to measure the pressure drop between the inlet and the outlet of the filter 15a, 15b. In one particular embodiment, the filtration device 9 can also include a circuit measuring the pressure drop between the upstream pressure gauge 18a and the downstream pressure gauge 18b and delivering a warning signal when the pressure drop exceeds a set value.

When the pressure drop in the filter 15a exceeds a set value, the flow of oil is then switched to the other filter 15b and the previously used filter 15a can then be cleaned. Then, the installation can be continuously operated.

In the embodiment shown, the pipe 10 is connected downstream of the pump to a first 3-way distribution device 12. Each of the three ways is then connected to a second 12 way distribution device 13 each of the ways of which is provided with a valve 14 and connected to a lance 5. Then, according to this embodiment, the pipe 11 supplies 36 lances. In order to supply the 72 lances, the system further comprises a second pipe 19 for the suction and re-injection of oil connected at the upstream end thereof to the tank 1 and at the downstream end thereof to the injection lances 5. The second pipe 19 is also provided with a pump 7, a filtration device 9 and a first 12 and a second 13 distribution device as in the case of the first pipe 11.

When the pumps 8 suck the crude oil out of the tank 1 and discharge it in the lances 5, a turbulent vortex volume appears around each lance 5.

Sections are chosen for the orifices 8a, 8b, 8c to be small enough so that the jet ejection pressure is sufficient for the radius of the vortex volume created around the lance 5 allowing the vortex volume to cut the vortex volumes caused by the adjacent lances 5.

The whole liquid crude oil positioned above the sediment is put in motion. The orifices 8a of the lances 5 oriented downwards hit the upper surface of the sediment which is then put back in suspension in the crude oil. The side orifices 8b, 8c create a vortex volume which kneads the oil through the volume of the tank 1 and thus prevents the sediments to settle down again.

It has been found that after an operation time, the sediment 3 almost disappeared from the whole surface of the bottom 1b of the tank 1, with only inorganic elements initially contained in the sediment remaining of said bottom 1b.

To know the end of the operation, the density of the crude oil is generally measured and the cleaning is stopped when the density reaches the value predetermined by the calculations carried out by the initial sampling of the crude oil and the sediment and the relative volumes of the sediment and the crude oil remaining in the tank for the cleaning operation.

It should be noted that in one embodiment of the invention, a system is provided with a storage tank 10 which makes it possible to reintroduce crude oil having physico-chemical characteristics which are different from those of the crude oil contained in the tank so as to obtain, upon completion of the operation and when the sediment is put back in suspension, a crude oil having set physico-chemical characteristics.

1. A system for putting back in suspension a sediment that has, by deposition, formed, a layer (3) on the bottom (1b) of a tank (1) with a floating roof (2) containing crude oil, said device comprising:
at least one pipe (11) for sucking out and re-injecting the oil contained in said tank (1);
a pump (7) for providing circulation of the oil in said pipe (113, a filtration device (9) intended to eliminate the inorganic elements contained in the crude oil; and
injection lances (5) carried by the floating roof (2) and each comprising at least one injection orifice (8a, 8b, 8c) sending a jet in the direction of the layer of sediment;
said suction and re-injection pipe (11) being connected, at the upstream end thereof, to the tank (1), and at the downstream end thereof, to the injection lances (5);
said system being characterised in that the filtration device (9) comprises at least a first (15a) and a second (15b) filter mounted in parallel and connected to the suction and re-injection pipe (11) by means of a switching device (16, 17) for directing the flow of oil selectively to the first (15a) or second filter (15b).

2. A system according to claim 1, characterised in that the filters (15a, 15b) are removable basket filters.

3. A system according to claim 1, characterised in that the switching device comprises one three-way (16) valve positioned upstream of the first (15a) and second filter (15b).

4. A system according to claim 3, characterised in that the switching device further comprises a second three-way valve (17) positioned downstream of the first (15a) and second (15b) filter.

5. A system according to claims 3 or 4, characterised in that the filtration device (9) comprises, for each filter, (15a, 15b) an upstream (18a) pressure gauge and a downstream (18b) pressure gauge positioned respectively upstream and downstream of the filter (15a, 15b).

6. A system according to claim 5, characterised in that it comprises a circuit measuring the pressure drop between the upstream pressure gauge (18a) and the downstream pressure gauge (18b) and delivering a warning signal when the pressure drop exceeds a set value.

7. A system according to claim 1, characterised in that the filtration device (9) is connected to the suction pipe (11) upstream of the pump (7).

8. A filtration system according to claim 1, characterised in that the lances (5) have heads (6) mounted for rotating freely with respect to the axis of the lance (5), said head (6) comprising at least two side injection orifices (8b, 8c), the axis of which does not cross the head rotation axis (6).

9. A filtration system according to claim 8, characterised in that the head (6) is further provided with a third orifice (8a) the outlet axis of which is oriented towards the bottom (1) of the tank (1).

10. A system according to one of claims 1 or 9, characterised in that it comprises a first n-way distribution device (12) for connecting the oil suction and re-injection conduit (11) to the oil injection lances (5).

11. A system according to claim 10, characterised in that it further includes n second p-way distribution devices (13) connected on one side to the first distribution device (12) and on the other side to p oil injection lances (5).

12. A system according to claim 1, characterised in that it further comprises at least a second suction pipe (19) connected, at the upstream end thereof, to the tank (1) and at the downstream end thereof to the injection lances (5) and provided with a second pump (7) for the circulation of oil in said second pipe (19) and a filtration device (9).

13. A method for putting back in suspension a sediment which has, by deposition, formed a layer (3) on the bottom of the tank (1) with a floating roof (2) containing crude oil, said method providing:
the suction of the crude oil out of the tank (1) using a pump (7) and an oil suction and re-injection pipe (11);
the filtration of the crude oil using a filtration device (9) comprising at least a first (15a) and a second (15b) filter mounted in parallel and connected to the suction and re-injection pipe (11) using a switching device (16, 17) for directing the flow of oil selectively to the first (15a) or the second (15b) filter;
the injection of the crude oil into the tank (1) using lances (5) carried by the floating roof (2), as they are vertically positioned above the sediment (3) and each comprising at least one orifice (8a, 8b 8c) sending a jet in the direction of the layer of sediment (3),
said method being characterised in that it provides to switch the oil flow from the first (15a) to the second (15b) filter or reversely and to carry out maintenance operations on the filter (15a) which receives no flow of oil.

14. A method for putting a sediment back in suspension according to claim 13, characterised in that it provides:
the measurement of the pressure drop between the inlet and the outlet of the filter (15a, 15b) which the flow of oil is directed to,
the comparison of the pressure drop with a set value;
the switching of the flow of oil to the filter (15a, 15b) which is not used if the measured pressure drop exceeds the set value.
